(19) United States
(12) Patent Application Publication
(10) Pub. No.: US 2015/0120485 A1
(43) Pub. Date: Apr. 30, 2015

(54) Method and System for Facilitating the Purchase and Sale of Used Mobile Devices

(71) Applicant: Chaim Nash, Montclair, NJ (US)

(72) Inventor: Chaim Nash, Montclair, NJ (US)

(21) Appl. No.: 13/998,355

(22) Filed: Oct. 24, 2013

(51) Int. Cl. G06Q 30/06

(52) U.S. Cl. CPC G06Q 30/0611
USPC 705/26.4

(57) ABSTRACT

This invention allows the owner of a mobile device capable of two way telecommunications such as a mobile phone to have said device remotely evaluated using an electronic connection and obtain a firm price for said mobile device. More particularly, the owner of a mobile phone may obtain a firm price for said mobile phone before sending said mobile phone to a mail in location.

### CROSS REFERENCE TO RELATED APPLICATIONS

None

### STATEMENT REGARDING FEDERALLY SPONSORED RESEARCH OR DEVELOPMENT

None

### BACKGROUND

The present invention generally relates to recycling of used mobile devices capable of two way telecommunications. While the most prevalent version of such devices is mobile phones, it is understood that this invention relates to the broader field of devices capable of two way telecommunications. More specifically, the present invention provides a method and system to facilitate the purchase and sale of used mobile devices capable of two way telecommunications. This invention allows an owner of a used mobile device such as a mobile phone to obtain a purchase price for said owner's used mobile phone without having to find a store or a kiosk that specializes in such purchases.

There has been an explosion in the use of portable electronic devices including mobile phones, PDA's, tablet computers, e-readers and other devices that are capable of two way electronic communications. The ICT Data and Statistics Division of the International Telecommunications Union (the United Nations Agency that deals with telecommunications) estimates that there are 6.8 billion active mobile phone subscriptions world wide, of which more than 325 million are in the United States. The Gartner Group estimates that annual sales of mobile phones are over 1.5 billion and others estimate that 165 million mobile phones are sold annually in the United States. What that means is that a significant number of mobile phones are being retired each year. Moreover, the cited numbers are limited to mobile phones and do not include PDA's table computers, e-readers and other devices that are capable of two way electronic communications. When those are added in, the turnover in such devices on an annual basis is staggering.

Such portable electronic devices continue to include various toxic elements including bromine, chlorine, lead, mercury, cadmium, chromium, cobalt, nickel, copper, tin, and antimony. While many manufacturers have taken steps to reduce the quantity of such toxic elements in portable electronic devices and no single device may have more than inconsequential quantities of such toxic elements, the aggregate is still a substantial threat to potable water supplies. In the best case, such devices are either reused or such toxic elements are recovered from them prior to disposal. In the worst case, they get thrown out with a homeowner's trash.

There is significant value in used mobile phones. The greatest value is achieved when the device is in good enough condition to recondition and sell as a less expensive alternative to a new mobile phone, and there is a substantial market for such less expensive used mobile phones outside of the United States. However, there is also value in the recycling of materials and parts that comprise the used mobile phones. Collection centers exist for the return of used mobile phones without discarding them as solid waste. Some are operated by charitable organizations and the owner gets a receipt for a tax deductible donation. Others are operated by third parties for the benefit of charitable organizations and may give a receipt for the donation, depending on how they are organized. Still others offer payment for the mobile phone upon receipt and verification of condition. An example of a website that offers both the opportunity to receive payment or the opportunity to donate to a charitable cause is grcrecycling.com, which also uses the address smartphonetrade-in.com for its return for payment program. Finally, some offer collection locations (e.g. kiosks) where the phone is accepted, analyzed and some payment is provided to the owner in the form of cash, credit, voucher or other form of value. Nonetheless, many users still prefer to discard their mobile phones as waste rather than go through the hassle of returning them with uncertain prospects of payment. Information relevant to the attempts to address these problems through the use of kiosks can be found in U.S. Pat. Nos. 8,200,533, 8,195,511, 8,239,262 and 7,881,965. A disadvantage of the kiosk approach is that the owner of the used mobile phone must determine the location of a kiosk and be willing to travel to the location of the kiosk to use it.

Given the cost of mobile phones, many owners would like to receive something for their used mobile phones rather than discard them. Currently, there are two different approaches that are used to provide owners of mobile phones with something of value for their used mobile phones. The first approach is taken by websites that do not commit on how much they will pay for a phone until it is sent to them. See, for example, GRCrecycling.com. Understandably, the typical owner is unwilling to send the phone to an unknown entity without knowing how much the owner will get paid. The owner may also have concerns about sending the mobile phone with the owner's personal data and information still on the mobile phone. The websites are unwilling to commit to a payment because they do not know the condition of the phone they will be receiving and therefore only offer hedged estimates. The second approach is the use of kiosks, where the user places the mobile phone in an examination chamber and the phone is examined and tested before a price quotation is provided. While this resolves the issue of the payment that will be received, the mobile phone owner still has to find a kiosk to use this system. These approaches do not appear to offer the owner of such portable electronic devices including mobile phones a sufficient incentive to use them, and thus a significant quantity of such mobile phones continue to end up in the general waste stream.

For the foregoing reasons, there is a need for a method and system that allows a purchaser of used mobile phones to determine the condition of the phone without the need of a kiosk and gives a potential purchaser of such used mobile phone sufficient confidence as to the value of the used mobile phone to induce said potential purchaser to commit to a purchase price before receiving the phone. Yet another need fulfilled by this invention is to allow an owner of a used mobile phone to obtain a commitment as to the purchase price for said owner's used mobile phone before sending it to the purchaser or turning it in at a store that sells mobile phones. Yet another need fulfilled by this invention is the providing of a sufficient incentive to the owner of a used mobile phone to sell it back to a purchaser rather than discarding it thus reducing the presence of such used mobile phones in solid waste stream.

### SUMMARY

The present invention is directed to satisfying the need for a method and system that allows a purchaser of used mobile phones to determine the condition of a used mobile phone and set a purchase price for said used mobile phone before physically receiving said used mobile phone. It is further directed to satisfying the need for a method whereby the owner of a used mobile phone obtains a commitment as to the purchase price of a used mobile phone before delivering it to a purchaser. It further directed to satisfying the need to give an owner of a used mobile phones a sufficient financial incentive to sell said used mobile phone back to a purchasers rather than discarding it and thus reducing the presence of such used mobile phones in solid waste.

The present invention is directed to a method that satisfies these needs by remotely analyzing used mobile phones through the use of a method or configured to perform such analysis. The first step of the method is the configuring of a processor to perform diagnostics on a used mobile phone via a phone connection or an internet connection or other similar electronic connection. The method continues with the establishment of an electronic communications connection between the configured processor and a used mobile phone which has one or more buttons, one or more keyboard keys, switches and/or a touchscreen capable of accepting touchscreen commands. The electronic communications connection is created by having a used mobile phone call a phone number establishing a wireless phone connection with said configured processor, or use an internet connection to connect to a website and thus establish a connection with said configured processor or use a physical connection to a local processor through a jack or other form of physical connection or other device which has an internet or other electronic connection with the configured processor. The electronic communications connection could also use a hard wired network with an access port that accepts a cable that connects to said used mobile phones, or wifi, blue tooth, or other similar type connections. Once an electronic communications connection has been established, the method continues with the delivery of instructions to said used mobile phone. Such instructions may include directing said used mobile phone to provide said configured processor with information such as the name of the manufacturer, the model number and the serial number or International Mobile Station Equipment Identity (IMEI) of said used mobile phone or in the alternative capturing such information directly from said used mobile phone. Such instructions cause said used mobile phone to test one or more of the buttons, screen display, touchscreen, keyboard keys, switches and/or touchscreen commands used by said used mobile phone to generate a result which is transmitted to said configured processor. Said configured processor determines from said result whether or not said button, keyboard key, switch and/or touchscreen command operates properly and stores that information for further use. This step may continue until all of the buttons, keyboard keys, switches and touchscreen commands have been tested or until enough have been tested to satisfy a potential purchaser. If said used mobile device has menus, such instructions may cause said used mobile phone to test one or more menu entries.

When the testing is completed, the method continues with said configured processor analyzing the results that it has stored and determining a purchase price for said used mobile phone based on said information. Once a purchase price is determined, information regarding said purchase price and the method for obtaining it (for example, how and where to send the phone) together with reference information to identify the phone and the analysis is returned to said used mobile phone allowing the owner of said used mobile phone to return the phone to obtain the purchase price. Said purchase price could take the form of a payment via check, electronic funds transfer, credit on a credit card account, credit to a debit card account, a debit card with a credit in the amount of the purchase price on it or other method of payment that is generally accepted, credit or voucher towards the purchase of a new used mobile phone or other form of payment.

In an alternate version of this invention, the owner of said used mobile phone is required to take pictures of said used mobile phone from one or more angles (front, back, showing sides with buttons or connection ports or jacks) and send said picture or pictures to said configured processor using said electronic communications connection, thus providing the configured processor with additional information to be considered as part of the analysis performed by said configured processor.

In a second alternate version of this invention, software or an application would be downloaded from the configured processor to said used mobile phone and the downloaded software or app would cause said used mobile phone to test said used mobile phone's buttons, screen display, touchscreen, keyboard keys, switches and/or touchscreen commands and send the results to said configured processor using the electronic communications connection.

In a third alternate version of this invention, said electronic communications connection is established via a local computer connected to said used mobile phone, the software is downloaded from the configured processor to said local computer and said local computer sends testing instructions to said used mobile phone. Said local computer then sends the results of such testing instructions to said configured processor.

Optional steps in this process include verifying that the identification number of said used mobile phone does not appear on any published list of stolen mobile phones and requiring that the owner of said used mobile phone provide a clear picture of a form of acceptable photo identification such as a driver's license, but such optional steps are not required for the invention to operate. Yet an additional optional step in the process includes verifying that the charger for said used mobile phone works by having it connected to said used mobile phone during the process Yet an additional optional step in the process includes checking any devices that connect to said used mobile phone to verify that said used mobile phone properly works with such other devices.

The references to used mobile phone herein also include other mobile devices that are capable of two way electronic communications via wireless phone line, wireless internet connection or physical connection to a local computer.

These and other features, aspects and advantages of the present invention will become better understood with reference to the following description [, drawing] and appended claims.

The present invention is also directed to a system that provides for the satisfaction of these needs by remotely analyzing used mobile devices capable of two way telecommunications such as mobile phones through the use of a method or configured to perform such analysis. In this form of the invention, the system comprises a processor, a mobile phone and an electronic communications connection between said mobile phone and said processor, wherein said processor is configured with software that is capable of extracting information from said used mobile phone, performing tests on such mobile phone and analyzing the information extracted and the test results to determine a purchase price for said used mobile phone.

In an alternate version of this invention, the processor is provided with access to various databases of information concerning used mobile phones to provide additional data for determining the price of such used mobile phone. Such databases may include information regarding the current price new phone of the same make and model and/or the current market price of a used phone and the cost for repairing various deficiencies in used mobile phones.

In yet another alternate version of this invention, the processor is provided with access to various databases of information concerning stolen mobile phones to verify that the mobile phone has not been reported as being stolen.

### DESCRIPTION

In the Summary of the Invention above, Detailed Description of the Invention and the claims below, [and in the accompanying drawings] reference is made to particular features including method steps of the invention. It is to be understood that the disclosure of the invention in this Specification does not include all possible combinations of such particular features. For example, where a particular feature is disclosed in the context of a particular aspect of embodiment of the invention, or a particular claim, that feature may also be used, to the extent possible, in combination with and/or in the context of other particular aspects and embodiments of the invention, and in the invention generally.

The term “comprises” and grammatical equivalents thereof are used herein to mean that other components and/or steps are optionally present. For example, a method comprising steps A, B and C can consist of only steps A, B and C, or can consist of components A, B and C plus one or more other steps or components. In addition, when reference is made to a method comprising two or more defined steps, the defined steps can be carried out in any order or simultaneously unless the context excludes that possibility and the method can include one or more other steps which are carried out before any of the defined steps, between two of the defined steps, or after all of the defined steps except where the context excludes that possibility. By way of more specific example, when the method includes running different sets of instructions on a used mobile phone, those sets of instructions can be run in any order unless it is explicit by the context that the instructions must be run in a specific order.

As used herein, certain terms are defined to clarify the intended meanings of those terms. These definitions apply regardless of whether or not the terms are capitalized. “Mobile device” or “mobile phone” means any device capable of two way electronic communications via a wireless phone, wireless internet, physical connection to a phone line or internet line, physical connection to a computer or other device that has a two way connection to the phone system or the internet or other communications network. Thus, for example, PDA's, tablet computers, e-readers are other electronic devices capable of two way electronic communications that would be included in this definition. As used in the phrase “used mobile phone”, the term “used” is not intended to connote any particular or minimum amount of use, and a “mobile phone” that is still in a sealed box from the factory is included within the definition of “Used.”

The term “configured processor”, as used herein, means a computer or other specific purpose processor that has been loaded with software that will enable it to do the tasks required of it herein and is capable of operating such software.

“Screen Display” means an electronic display which is not a Touchscreen (as defined below) which displays information for the person using the used mobile phone, which displays may be LCD or LED or other forms of electronic display.

“Touchscreen” means an electronic display which a person can control by touching it with fingers or another device (e.g. stylus). “Touchscreen command” means a touching of the touchscreen by a finger or stylus or the movement of the finger or stylus on the touchscreen which provides input to said used mobile phone. “Stylus” means any apparatus or device capable of causing the touchscreen to recognize input when such apparatus or device is touched against the touchscreen.

A method according to the present invention for remote analysis of a used mobile phone and financial compensation for delivering said used mobile phone comprises the steps of configuring a processor so that it can perform testing and diagnostics on used mobile phones, establishing an electronic communications connection between said configured processor and a used mobile phone, sending instructions from said configured processor to said used mobile phone causing said used mobile phone to execute instructions and send information to said configured processor, and said configured processor then analyzing the information sent to it by said used mobile phone and determining a purchase price for said used mobile phone.

In the step of configuring a processor so that it can perform testing and diagnostics on used mobile phones, diagnostic software appropriate for each type of used mobile phone is loaded on a processor that is capable of connecting to used mobile phones through an internet connection or via a dial up connection. Said diagnostic software is capable of testing at least one and preferably all of the buttons, screen display, touchscreen, keyboard keys, switches and touchscreen commands used by said used mobile phone and determining based on the results whether such button, keyboard key, switch or touchscreen command operated properly. Said diagnostic software is further capable of testing at least one and preferably all of the menu options offered by said used mobile phone and each of the position that can be taken by a button, keyboard key, switch and touchscreen command and determining based on the results if such button, keyboard key, switch or touchscreen command operates properly.

In the step of establishing an electronic communications connection between said configured processor and a used mobile phone, said used mobile phone can connect to said configured processor through an internet connection whereby said used mobile phone connects directly to the internet, through a WIFI, blue tooth or similar network to the internet, through a connection to a hard wired network with internet access or through a local computer that has internet access. Said connection to a local computer can be via a physical connection, a WIFI, blue tooth or similar connection or connection using other electronic means. Said used mobile phone may also connect to said configured processor by dialing a phone number that provides a direct connection to said configured processor.

In the step of sending instructions from said configured processor to said used mobile phone causing said used mobile phone to execute said instructions and send information to said configured processor, said instructions include instructions for said used mobile phone to send information that is stored on a used mobile phone, such as the name of the manufacturer, the model number and the serial number of said used mobile phone. If one or more photographs of said used mobile phone has been stored on the phone with identifying information that would enable such photographs to be identified as pictures of said used mobile phone, such instructions from the configured processor may cause such photograph(s) to be transmitted to said configured processor. Said instructions may also include instructions to execute instructions on said mobile phone. The instructions to be executed on said used mobile phone may include instructions to test one or more of the buttons, keyboard keys, screen display, touchscreen, switches and touchscreen commands that are used by said used mobile phone. Said instructions may include instructions to test every possible use of said buttons, keyboard keys, screen display, touchscreen, switches and said touchscreen commands, and to test each menu entry until all possible menu entries have been tested. This is not intended to be an exhaustive list of the various forms that such instructions may take and any form of instruction that causes a mobile phone to transmit information may be used.

In the step of said configured processor analyzing the information sent to it by said used mobile phone and determining a purchase price for said used mobile phone, said configured processor may do this by assigning a value to each of the responses that it is possible for said used mobile phone to give in response to instructions given to said used mobile phone and then calculating an overall total or category totals for use in determining the condition of the phone. In the alternative, said configured processor may assign a value to ranges of responses given by said used mobile phone in response to instructions given to said used mobile phone and perform calculations based on said ranges to determine values. In yet another alternative, said configured processor may have a table consisting of a value that is pre-assigned for each possible combination of responses that could be given by a mobile phone in response to the instructions given to said used mobile phone and determining a value by reference to said table. In yet another alternative, said configured processor may have a table that is based on quantities of responses by category and includes a value for each combinations of the results by category that has been pre-assigned. This is not intended to be an exhaustive list of the methods that may be used in determining a purchase price based on the analysis of the testing performed on said used mobile phone.

In yet other embodiments of this invention, one or more of the following additional steps may be included in the method: (1) taking pictures of said used mobile phone loading said pictures on said used mobile phone with identifying information; (2) taking pictures of said used mobile phone and sending them by email to said configured processor; (3) taking pictures of said used mobile phone and sending them to a phone number provided by said configured processor; (4) taking pictures of said used mobile phone and uploading them to an electronic address provided by said configured processor; (5) sending the determined purchase price for said used mobile phone together with instructions for delivery and identifying information to be used when said used mobile phone is delivered; (6) paying said determined purchase price upon (a) receipt of said used mobile phone, (b) receipt of said identifying information and (c) confirmation that said used mobile phone that is received is the same as said used mobile phone that was analyzed; (7) guaranteeing an owner of said used mobile phone that a payment of the determined purchase price will be made to said owner price upon (a) receipt of said used mobile phone, (b) receipt of said identifying information and (c) confirmation that said used mobile phone that is received is the same as said used mobile phone that was analyzed; (8) using said pictures of said used mobile phone in calculating said determined purchase price; (9) sending any personal information and data on said used mobile phone to an email address or other used mobile phone number or other electronic location designated by asking said owner of said used mobile phone and then erasing said personal information and data from said used mobile phone; (10) downloading any personal information and data on said used mobile phone to a file for storage on a memory device and sending said file or memory device to said owner of said used mobile phone; (11) erasing any personal information and data on said used mobile phone; (12) testing whether said used mobile phone has a charger port which is capable of being used to charge the used mobile phone, (13) testing whether the used mobile phone will accept a charge when a charger is plugged into the charger port; and/or (14) testing whether said used mobile phone properly operates with any other device that is intended to be connected to said used mobile phone. In addition, if said owner of said used mobile phone is at a store that sells mobile phones at the time that said used mobile phone is connected to said configured processor and analyzed, said store can take possession of the phone and receive the determined purchase price instead of said owner to facilitate said owner's purchase of a new mobile phone.

In the possible steps of taking pictures of said used mobile phone loading said pictures on said used mobile phone with identifying information, taking pictures of said used mobile phone and sending them by email to said configured processor, taking pictures of said used mobile phone and sending them to a phone number provided by said configured processor, and taking pictures of said used mobile phone and uploading them to an electronic address provided by said configured processor, the pictures may be any electronic format and ideally should show all surfaces of said used mobile phone, but may be used even if only a portion of the surfaces of said used mobile phone are shown. Yet an additional possible step is providing instructions for the taking of pictures of said used mobile phone. Said instructions may be provided on a website, by email, or by electronic signal to said used mobile phone causing information to display on said used mobile phone.

In the possible step of sending the determined purchase price for said used mobile phone together with instructions for delivery and identifying information to be used when said used mobile phone is delivered, said information may be sent to said used mobile phone, to another electronic location designated by said owner of said used mobile phone, to an email address, or by displaying said information on a website. Said instructions for delivery may be to a physical address or to a store that sells mobile devices and has agreed to repurchase mobile phones at the determined purchase price if the owner of said used mobile phone has obtained a determined purchase price that is guaranteed. Sending the determined purchase price means advising said owner of the amount that would be paid for said used mobile phone upon delivery of said used mobile phone.

In the possible step of paying said determined purchase price upon (a) receipt of said used mobile phone, (b) receipt of said identifying information and (c) confirmation that said used mobile phone that is received is the same as said used mobile phone that was analyzed, said payment may take the form of currency, electronic funds transfer, coupons, credit to an account, gift cards, gift certificates, check, or any other method of transferring value to said owner. Said identifying information may be a combination of symbols, numbers and letters supplied by said configured processor, a combination of words with symbols, numbers and letters, a bar code, an image or other form of identification. Confirmation that said used mobile phone received is said used mobile phone that was analyzed may be done by comparison of serial numbers, comparison of other testing results obtained by said configured processor with testing results obtained by applying the same tests to said used mobile phone that is delivered, or other suitable means.

In the possible step of guaranteeing an owner of said used mobile phone that a payment of the determined purchase price will be made to said owner price upon (a) receipt of said used mobile phone, (b) receipt of said identifying information and (c) confirmation that said used mobile phone that is received is the same as said used mobile phone that was analyzed, said guaranty can take the form of an identifying number, coupon, voucher, or third party guaranty.

In the possible step of using said pictures of said used mobile phone in calculating said determined purchase price, said use may include pixel by pixel analysis of said picture, comparison of said picture with a picture of an mobile phone of the same model, a comparison of the picture with other reference data for an mobile phone of the same model and/or a visual inspection and entry of data based on such visual inspection.

In the possible steps of sending personal information and data on said used mobile phone to an email address or other mobile phone number or other electronic location designated by asking said owner of said used mobile phone and then erasing said personal information and data from said used mobile phone or downloading any personal information and data on said used mobile phone to a file for storage on a memory device and sending said file or memory device to said owner of said used mobile phone, it is anticipated that this option will be requested if not required by owners of mobile phones as they will not wish to lose the personal information and data on said used mobile phone. Moreover, it is anticipated that said owner of said used mobile phone will want to verify that personal data has been removed before delivering said used mobile phone to anyone. No limitation is intended on the possible locations or forms that such sending and/or downloading may take.

In the possible steps of testing whether said used mobile phone is capable of being charged when a charger is plugged into it and/or testing whether said used mobile phone properly operates with any other device that is intended to be connected to said used mobile phone, it is anticipated that said owners will generally have a charging device available for said used mobile phone but probably may not have other devices available—particularly if said owner has not used any of the devices that may be connected to said used mobile phone.

In an alternative approach, said configured processor delivers diagnostic software to said used mobile phone that will operate on such mobile phone to perform said diagnostics, and then return the results of such diagnostics to said configured processor. This alternative approach would be the same as the first described approach except for the fact that the software would operate on said used mobile phone rather than from said configured processor. Yet a further alternative approach would be a combination of the software operating in part on said configured processor and in part on said used mobile phone.

In yet other embodiments of this invention, the invention is described as a system comprising a processor configured with software capable of testing a mobile phone, extracting information from said mobile phone and/or performing diagnostics on said mobile phone, a means for said configured processor to communicate with a used mobile phone, and a means for said used mobile phone to communicate with said configured processor, wherein the configured processor is further configured to analyze said used mobile phone based on the information available to said configured processor and determine a purchase price for said used mobile phone.

The configured processor may be a general purpose computer, a specific purpose computer, a processing device that is not categorized as a computer but is capable of compiling and operating software and transmitting and receiving data electronically, or similar device. It is anticipated that in many instances, the configured processor will be a general purpose computer.

The means for the configured processor to communicate with a mobile phone may be an internet connection, a connection to a similar network, a connection to a virtual private network, a phone line connection, a wifi connection or other form of network connection.

A mobile phone may be any reasonably portable electronic device capable of two way electronic communications, such as mobile phones, personal assistants, tablet computers and e-readers. While it is anticipated that this system will be most useful for used mobile phones, it is anticipated that this system would also be useful for such other devices capable of two way electronic communications.

The means for said used mobile phone to communicate with the configured processor may be an internet connection, a connection to a similar network, a connection to a virtual private network, a phone line connection, a WiFi, blue tooth or similar connection or other form of network connection.

The configuration of the configured processor to use diagnostics software may take the form of an app or software that is downloaded to the used mobile phone and gathers the required information to send back to said configured processor. In the alternative, it may take the form of operating on said configured processor and sending commands to said used mobile phone causing said used mobile phone to send information to said configured processor. Said commands may further take the form of simulating touchscreen commands or the pushing of buttons, keyboard keys or moving switches from one position to another. Such instructions may take the form of selecting each menu entry and transmitting the information displayed as a result of selecting such menu entry to said configured processor. This is not intended to be an exhaustive list of the various forms that such commands may take and any form of command that causes a mobile phone to transmit information may be used.

There are many methods that could be used by a configured processor to analyze said used mobile phone. One alternative is for a value to be assigned to each of the possible responses that could be provided as a result of a touchscreen command, simulated press of a button or keyboard key or simulated movement of a switch and then combining such values for an aggregate score or comparing such values against preset combinations of values. In the alternative, said configured processor may assign a value to ranges of responses given by said used mobile phone in response to a touchscreen command, simulated press of a button or keyboard key or simulated movement of a switch and then combining such values for an aggregate score or comparing such values against preset combinations of values. In yet another alternative, said configured processor may have a table consisting of a value that is pre-assigned for each possible combination of responses that could be provided as a result of a touchscreen command, simulated press of a button or keyboard key or simulated movement of a switch. In yet another alternative, said configured processor may have a table that is based on quantities of responses by category and includes a value for each combination of the results by category that has been pre-assigned. One example of such table that could be used for determining a purchase price is shown in the chart below.

| | | | | | | | | | Valid IMEI, | Looks Like |
|---|---|---|---|---|---|---|---|---|---|---|
| | | | | | | | | | Carrier, | New (A) or |
| | | | Unit powers | | | | | | Model, | Looks are |
| | Touch | | up and | | | | | | Stolen | acceptable |
| | screen | Keyboard | Charging | LCD | | | Wifi/Blue | | Phone | (B) |
| | functions | functions | port | functions | LCD | Broken | Tooth | Jack | Database | (some |
| Grade | properly | properly | works | properly | cracked | Digitizer | Connectivity | Connectivity | Checks | marks) |
| #1 | Yes | Yes | Yes | Yes | No | No | Yes | Yes | All Clear | A/B |
| #2 | All | Yes | Yes | No | N/A | Yes | Yes | Yes | All Clear | A/B |
| #3 | No | N/A | N/A | N/A | N/A | Yes | N/A | N/A | All Clear | A/B |
| | power | | | | | | | | | |
| CR | Yes | Yes | Yes | Yes | No | No | Yes | Yes | All Clear | A/B |
| #1BD | Yes | Yes | Yes | Yes | No | Yes | Yes | Yes | All Clear | A/B |

Typically, this invention would be used by a person who owns a mobile phone who is considering replacing it to obtain a purchase price for the mobile phone before committing to the purchase of a new phone. The person would either call a phone number or use a website connection to connect to a processor that was configured with software to analyze the mobile phone. In the best situation, such person would have taken photographs of the mobile phone and stored them on the mobile phone before beginning, although that is not necessary for the method to work. Once the mobile phone established an electronic communications connection with the configured processor, the configured processor would extract information concerning the manufacturer, model and serial number of the mobile phone in order to determine which instructions to send to said mobile phone and would commence sending instructions and obtaining results from said mobile phone. When the configured processor completed sending instructions and receiving responses from said mobile phone, said configured processor would then compare the responses against a database consisting of various tables of results and use the purchase price from the table that most closely matched the results from the mobile phone being tested. The configured processor would then send a message to said mobile phone consisting of the amount of the purchase price, instructions (including a prepaid shipping label) for returning said mobile phone to the purchaser, and an identifying number or code which would be included on the shipping label. The owner of said mobile phone would then ship the used mobile phone to the purchaser and upon receipt of the used mobile phone, the purchaser would send the purchase price to the owner. It is anticipated that if the owner chose to take the mobile phone into a store and have the store do the connection to the configured processor, the store might elect to credit the amount of the purchase price towards the purchase of a new phone and return the used mobile phone to the purchaser for the owner.

This invention satisfies the need for a method that provides the owner of a used mobile phone with a greater incentive to recycle and thereby addresses the need to reduce the amount of toxic substances included in our waste stream. This invention further satisfies the need and desire of used mobile phone owners to receive something of value for their used mobile phones.

I claim as my invention the following:

1. A method for remote analysis of a mobile device and financial compensation for delivering said used mobile device comprising:
Configuring a processor so that it can perform diagnostics on used mobile devices;
Establishing an electronic communications connection between said processor and a used mobile device;
Sending instructions from said processor to said used mobile device causing said used mobile device to send information to said processor;
Said processor using the electronic communications connection to perform diagnostics on said used mobile device to generate additional information; and
Said processor then analyzing the information sent to it by said used mobile device and said additional information generated by the diagnostics to determine a purchase price for said used mobile device.

2. The method according to claim 1 wherein one or more pictures is taken of said used mobile device, said picture(s) is sent to said processor using said electronic communications connection, and said processor then analyzes the information sent to it by said used mobile device, said additional information generated by the diagnostics and said picture(s) to determine a purchase price for said used mobile device.

3. The method of claim 1 wherein the determined purchase price is sent to said used mobile device with a guarantee that if said used mobile device is sent to a designated location within a limited period of time, the owner of said used mobile device will be paid the determined purchase price.

4. The method of claim 2 wherein the determined purchase price is sent to said used mobile device with a guarantee that if said used mobile device is sent to a designated location within a limited period of time, the owner of said used mobile device will be paid the determined purchase price.

5. The method of claim 3 wherein said processor also checks a database to determine if said used mobile device is stolen and if the information obtained from said used mobile device is consistent with the information in said database concerning said mobile device.

6. The method of claim 4 wherein said processor also checks a database to determine if said used mobile device is stolen and if the information obtained from said used mobile device is consistent with the information in said database concerning said mobile device.

7. The method of claim 5, wherein the personal information and data on said used mobile device is downloaded to a location or device designated from said used mobile device or transmitted to an email address or other mobile device number designated from said used mobile device and then said processor sends instructions to said used mobile device to erase all such personal information and data on said used mobile device.

8. The method of claim 6, wherein the personal information and data on said used mobile device is downloaded to a location or device designated from said used mobile device or transmitted to an email address or other mobile device number designated from said used mobile device and then said processor sends instructions to said used mobile device to erase all such personal information and data on said used mobile device.

9. A method for remote analysis of a mobile device and financial compensation for delivering said used mobile device comprising:
Configuring a processor so that it can perform diagnostics on mobile devices;
Establishing an electronic communications connection between said processor and a mobile device;
Sending instructions from said processor to said used mobile device causing said used mobile device to send information to said processor;
Sending instructions from said processor to said used mobile device causing said used mobile device to perform diagnostics on itself to generate results and sending said results to said processor; and
Said processor then analyzing the information sent to it by said used mobile device and said results generated by said diagnostics to determine a purchase price for said used mobile device.

10. The method according to claim 9 wherein one or more pictures is taken of said used mobile device, said picture(s) is sent to said processor using said electronic communications connection, and said processor then analyzing the information sent to it by said used mobile device, said results generated by said diagnostics and said picture(s) to determine a purchase price for said used mobile device.

11. The method of claim 9 wherein the determined purchase price is sent to said used mobile device with a guarantee that if said used mobile device is sent to a designated location within a limited period of time, the owner of said used mobile device will be paid the determined purchase price.

12. The method of claim 10 wherein the determined purchase price is sent to said used mobile device with a guarantee that if said used mobile device is sent to a designated location within a limited period of time, the owner of said used mobile device will be paid the determined purchase price.

13. The method of claim 11 wherein said processor also checks a database to determine if said used mobile device is stolen and if the information obtained from said used mobile device is consistent with the information in said database concerning said mobile device.

14. The method of claim 12 wherein said processor also checks a database to determine if said used mobile device is stolen and if the information obtained from said used mobile device is consistent with the information in said database concerning said mobile device.

15. The method of claim 13, wherein the personal information and data on said used mobile device is downloaded to a location or device designated from said used mobile device or transmitted to an email address or other mobile device number designated from said used mobile device and then said processor sends instructions to said used mobile device to erase all such personal information and data on said used mobile device.

16. The method of claim 14, wherein the personal information and data on said used mobile device is downloaded to a location or device designated from said used mobile device or transmitted to an email address or other mobile device number designated from said used mobile device and then said processor sends instructions to said used mobile device to erase all such personal information and data on said used mobile device.

17. A method for remote analysis of a mobile device and financial compensation for delivering said used mobile device comprising:
Configuring a processor with diagnostic software for a mobile devices that operates on a mobile device;
Establishing an electronic communications connection between said processor and a used mobile device;
Downloading said diagnostic software from said processor to said used mobile device;
Sending instructions from said processor to said used mobile device causing said used mobile device to use said diagnostic software to perform diagnostics on itself and send the results of said diagnostics to said processor;
Sending instructions from said processor to said used mobile device causing said used mobile device to send certain information stored in said used mobile device to said processor; and
Said processor then analyzing the information sent to it by said used mobile device and said results generated by said diagnostics software to determine a purchase price for said used mobile device.

18. The method according to claim 17 wherein one or more pictures is taken of said used mobile device, said picture(s) is sent to said processor using said electronic communications connection, and said processor then analyzing the information sent to it by said used mobile device, said results generated by said diagnostics and said picture(s) to determine a purchase price for said used mobile device.

19. The method of claim 17 wherein the determined purchase price is sent to said used mobile device with a guarantee that if said used mobile device is sent to a designated location within a limited period of time, the owner of said used mobile device will be paid the determined purchase price.

20. The method of claim 18 wherein the determined purchase price is sent to said used mobile device with a guarantee that if said used mobile device is sent to a designated location within a limited period of time, the owner of said used mobile device will be paid the determined purchase price.

21. The method of claim 19 wherein said processor also checks a database to determine if said used mobile device is stolen and if the information obtained from said used mobile device is consistent with the information in said database concerning said mobile device.

22. The method of claim 20 wherein said processor also checks a database to determine if said used mobile device is stolen and if the information obtained from said used mobile device is consistent with the information in said database concerning said mobile device.

23. The method of claim 21, wherein the personal information and data on said used mobile device is downloaded to a location or device designated from said used mobile device or transmitted to an email address or other mobile device number designated from said used mobile device and then said processor sends instructions to said used mobile device to erase all such personal information and data on said used mobile device.

24. The method of claim 22, wherein the personal information and data on said used mobile device is downloaded to a location or device designated from said used mobile device or transmitted to an email address or other mobile device number designated from said used mobile device and then said processor sends instructions to said used mobile device to erase all such personal information and data on said used mobile device.

25. A method for remote analysis of a mobile device and financial compensation for delivering said used mobile device comprising:
Configuring a processor with diagnostic software for mobile devices;
Connecting a local computer via the Internet to said processor;
Downloading said diagnostic software to said local computer;
Connecting a used mobile device to said local computer;
Sending instructions to said diagnostic software causing said diagnostic software to perform diagnostics on itself and send the results of said diagnostics to said local computer;
Sending instructions from said local computer to said used mobile device causing said used mobile device to send certain information stored in said used mobile device to said local computer; and
Said local computer sending said information and said results of said diagnostics to said processor;
Said processor using said results generated by said diagnostics software and said information obtained by said local computer from said used mobile device to determine a purchase price for said used mobile device.

26. The method according to claim 25 wherein one or more pictures is taken of said used mobile device, said picture(s) is sent to said processor using said electronic communications connection, and said processor then analyzing the information sent to it by said used mobile device, said results generated by said diagnostics and said picture(s) to determine a purchase price for said used mobile device.

27. The method of claim 25 wherein the determined purchase price is sent to said used mobile device with a guarantee that if said used mobile device is sent to a designated location within a limited period of time, the owner of said used mobile device will be paid the determined purchase price.

28. The method of claim 26 wherein said processor also checks a database to determine if said used mobile device is stolen and if the information obtained from said used mobile device is consistent with the information in said database concerning said mobile device.

29. The method of claim 27 wherein said processor also checks a database to determine if said used mobile device is stolen and if the information obtained from said used mobile device is consistent with the information in said database concerning said mobile device.

30. The method of claim 28, wherein the personal information and data on said used mobile device is downloaded to a location or device designated from said used mobile device or transmitted to an email address or other mobile device number designated from said used mobile device and then said processor sends instructions to said used mobile device to erase all such personal information and data on said used mobile device.

31. The method of claim 29, wherein the personal information and data on said used mobile device is downloaded to a location or device designated from said used mobile device or transmitted to an email address or other mobile device number designated from said used mobile device and then said processor sends instructions to said used mobile device to erase all such personal information and data on said used mobile device.

32. I claim a system for remotely analyzing mobile devices comprising:
A processor;
Diagnostic software capable of extracting information from a mobile device; and
An electronic communications system capable of connecting a mobile device and said processor;
Wherein an electronic communications connection is established between said processor and a used mobile device; and
Wherein said processor is configured to use said diagnostic software to extract information from said used mobile device; and
Wherein said processor is configured to analyze said used mobile device based on the information extracted by said processor and to determine a purchase price for said used mobile device.

33. The system according to claim 32 wherein one or more pictures is taken of said used mobile device, said picture(s) is sent to said processor using said electronic communications connection, and said processor then analyzes the information sent to it by said used mobile device, said results generated by said diagnostics and said picture(s) to determine a purchase price for said used mobile device.

34. The system of claim 32 which is further comprised of a database of information concerning mobile devices; wherein said processor also checks said database to determine if said used mobile device is stolen and if the information obtained from said used mobile device is consistent with the information in said database concerning said mobile device.

35. The system of claim 32, which is further comprised of a second processor for the secure storage of personal information and data copied from a used mobile device so that the owner of the used mobile device is able to access it and load it on a new mobile device.
